(19) United States
(12) Patent Application Publication
(10) Pub. No.: US 2019/0230499 A1
(43) Pub. Date: Jul. 25, 2019

(54) Methods and Apparatus for Indicating and Implementing of New UE Category

(71) Applicant: HFI Innovation Inc., Hsinchu County (TW)

(72) Inventors: Feifei Sun, Beijing (CN); Per Johan Mikael Johansson, Kungsangen (SE); Yuanyuan Zhang, Beijing (CN)

(21) Appl. No.: 16/369,294

(22) Filed: Mar. 29, 2019

Related U.S. Application Data
(63) Continuation of application No. PCT/CN2017/099546, filed on Aug. 30, 2017.

(30) Foreign Application Priority Data
Sep. 30, 2016 (CN) PCT/CN2016/101218

(51) Int. Cl. H04W 8/24; H04W 24/08; H04L 1/18; H04W 72/04; H04W 74/08; H04W 4/80; H04W 76/27

(52) U.S. Cl. CPC H04W 8/24; H04W 24/08; H04L 1/1812; H04W 76/27; H04W 74/0833; H04W 4/80; H04W 72/042

(57) ABSTRACT

Methods and apparatus are provided for handling of new UE capability. In one novel aspect, the UE reports a new UE capability to an eNB, determines whether the eNB supports the new UE capability and monitors a new DCI format to implement the new UE capability in the USS if the eNB supports the new UE capability, otherwise, monitors for a default DCI format to implement the default UE capability by the UE. In one embodiment, the UE is a NB-IoT device and reports the new UE capability in MSG3. In one embodiment, the UE obtains a configuration in system information to determine whether the eNB supports the new UE capability. In another embodiment, the UE obtains an indication in a dedicated RRC signaling to determine whether the eNB supports the new UE capability. In one embodiment, the new DCI format includes an indicator for a HARQ process number.

### CROSS REFERENCE TO RELATED APPLICATIONS

This application is filed under 35 U.S.C. § 111(a) and is based on and hereby claims priority under 35 U.S.C. § 120 and § 365(c) from International Application No. PCT/CN2017/099546, with an international filing date of Aug. 30, 2017, which in turn claims priority from PCT application PCT/CN2016/101218, entitled “METHODS AND APPARATUS FOR INDICATING AND IMPLEMENTING OF NEW UE CATEGORY” filed on Sep. 30, 2016. This application is a continuation of International Application No. PCT/CN2017/099546, which claims priority from PCT Application No. PCT/CN2016/101218. International Application No. PCT/CN2017/099546 is pending as of the filing date of this application, and the United States is a designated state in International Application No. PCT/CN2017/099546. This application claims priority under 35 U.S.C. § 120 and § 365(c) from PCT Application Number PCT/CN2016/101218 filed on Sep. 30, 2016. The disclosure of each of the foregoing documents is incorporated herein by reference.

### TECHNICAL FIELD

The disclosed embodiments relate generally to wireless communication, and, more particularly, to indication and implementation of new UE capability.

### BACKGROUND

Machine-Type Communication (MTC) is an important revenue stream for operators and has a huge potential from the operator perspective. Lowering the cost of MTC user equipment (UEs)/devices is an important enabler for the implementation of the concept of “internet of things” (IOT). Many MTC devices are targeting low-end (low average revenue per user, low data rate) applications that can be handled adequately by GSM/GPRS. Owing to the low-cost of these devices and good coverage of GSM/GPRS, there is very little motivation for MTC UE suppliers to use modules supporting the LTE radio interface. In order to ensure that there is a clear business benefit to MTC UE vendors and operators for migrating low-end MTC devices from GSM/GPRS to LTE networks, a new type of terminal, i.e. low cost (LC) MTC UE, is introduced in Rel-11. The cost of the LC-MTC UEs is tailored for the low-end of the MTC market to be competitive with that of GSM/GPRS terminals. The low cost MTC device/UE is characterized by: 1) One Rx antenna; 2) Downlink and uplink maximum TBS size of 1000 bits; 3) Bandwidth reduction (BR)—resources for each channel transmission are limited to contiguous 6 PRBs (1.4 MHz) for cost reduction, and 4) Coverage enhancement—some applications of LC-MTC UEs will require 15-20 dB coverage extension and repeated transmission is a common technique to compensate penetration losses.

In LTE Rel. 12, it is shown that the implementation of half-duplex FDD (HD-FDD) MTC with single receiving antenna is cost-competitive. The bandwidth reduction technique can offer further cost reduction. The UE with bandwidth reduction (BR-UE) can be implemented with lower cost by reducing the buffer size, clock rate for signal processing, and so on. In the IoT and/or MTC traffic, there is a lot of infrequent small UL traffic data, e.g., up to 100˜200 bytes uplink (UL) traffic periodically reported 1/hour to 1/year.

Recently, new UE categories, for example, with larger TBS and/or more than one HARQ process and/or a larger bandwidth (BW) (e.g., a UE with larger RF bandwidth) are introduced. In order to support the new UE capability, e.g., UE with more than one HARQ process, or a larger BW, there are some problems that need to be solved.

First, the current DCI format could not work for the new capability UE, for example, UE with more than one HARQ process and/or a larger BW. So, for the UE with more than one HARQ process, a signaling, e.g. a new DCI format with HARQ process number indication is needed. So, for the UE with a larger TBS, a signaling, e.g. a new DCI format with a larger TBS indication is needed. For the UE with a larger TBS, a signaling, e.g. a new DCI format with a larger BW indication is needed. The above signaling could be combined within one signaling indication, e.g. a new DCI format.

Second, during the procedure, UE and eNB need a handshake to enable the new UE capability e.g., support of more than one HARQ process and/or a resource allocation within larger BW. How to report UE capability and when to monitor for new DCI format needs to be solved.

Third, how to inform UE by the eNB that it can support new UE capability also needs to be solved.

In NB-IoT system, narrowband physical random-access channel (NPRACH) resources for each coverage level can be partitioned into one or two groups for single and/or multi-tone MSG3 transmission. Since there is no restriction on NPRACH resource configuration for multi-tone MSG3 transmission. The configuration of that there is no NPRACH resource for single-tone or multi-tone MSG3 transmission may happen. In this case, UEs who are capable of multi-tone MSG3 transmission can only select NPRACH resource in coverage level 1 and set max transmission power. However, if those UEs are in normal coverage but transmit NPRACH with max power, it will impact on the UE in coverage extended/coverage extreme mode. Therefore, it is benefit to fix this problem.

### SUMMARY

Methods and apparatus are provided for handling of new UE capability. In one novel aspect, the UE reports one or more new UE capability to an eNB, determines whether the eNB supports the new UE capability and monitors a new DCI format to implement the new UE capability in the UE-specific search space (USS) if the eNB supports the new UE capability, otherwise, monitors for a default DCI format to implement the default UE capability by the UE.

In one embodiment, the UE with the new UE capability is a narrowband IoT device. In another embodiment, the UE capability is selected from a capability group comprising: UE supporting of more than one HARQ processes, a new UE category with a larger buffer size, a new UE capability supporting of wide bandwidth, and a new UE capability supporting of larger TBS. In yet another embodiment, the UE reports the new UE capability in MSG3.

In one embodiment, the UE obtains a configuration in system information (SI) to determine whether the base station supports the new UE capability. In another embodiment, the UE obtains an indication in a dedicated RRC signaling to determine whether the base station supports the new UE capability. In one embodiment, the dedicated RRC signaling is in MSG4. In another embodiment, the new UE capability indication is implied by a presence of a configuration of a DL control channel. In yet another embodiment, the new UE capability indication is explicitly indicated by an information element in a RRC message.

In one embodiment, the new DCI format for the new UE capability includes an indicator for a HARQ process number. In another embodiment, the UE implements the new UE capability by mapping a new capability indicator in DCI to a new element and implementing the default UE capability by mapping a default capability indicator in the DCI to a default element.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates an exemplary mobile communication network with UEs supporting new UE capability in accordance with embodiments of the current invention.

FIG. 2A illustrates an exemplary message procedure of the UE reporting the new capability and obtaining configuration of eNB support of the new capability in accordance with embodiments of the current invention.

FIG. 2B illustrates exemplary DCI formats in supporting of the new UE capability in accordance with embodiments of the current invention.

FIG. 3 illustrates an exemplary the message procedure of UE obtaining the support of the new UE capability from the eNB in accordance with embodiments of the current invention.

FIG. 4A illustrates an exemplary message procedure of UE reporting the new UE capability in accordance with embodiments of the current invention.

FIG. 4B illustrates an exemplary flow chart of UE reporting NPRACH in accordance with embodiments of the current invention.

FIG. 4C illustrates exemplary diagrams of PRACH resource reserved for different capability in accordance with embodiments of the current invention.

FIG. 5 illustrates an exemplary message procedure of the UE reporting the new UE capability and obtaining confirmation from the eNB in accordance with embodiments of the current invention.

FIG. 6 illustrates an exemplary flow chart of UE reporting the new category in accordance with embodiments of the current invention.

FIG. 7 illustrates an exemplary flow chart of UE reporting the new category after determining the support of the new UE capability from the eNB in accordance with embodiments of the current invention.

FIG. 8 illustrates an exemplary flow chart UE with new UE capability for PRACH power ramping in accordance with embodiments of the current invention.

FIG. 9 illustrates an exemplary flow chart of UE implementing the new UE capability in accordance with embodiments of the current invention.

FIG. 10 illustrates an exemplary flow chart of for PRACH power ramping in accordance with embodiments of the current invention.

FIG. 11 illustrates a specific procedure for PRACH power ramping in accordance with embodiments of the current invention.

### DETAILED DESCRIPTION

Reference will now be made in detail to some embodiments of the invention, examples of which are illustrated in the accompanying drawings.

In order to increase the bit rate, to reduce latency or to save UE power consumption, a new UE category or capability in introduced in a communication system. Some techniques can be used for a new UE category/capability, such as support of multiple HARQ process, larger BW, or increasing MAX TBS, that is a larger MAX TBS. In order to enable the feature(s), i.e., eNB can schedule multiple HARQ process, schedule a transport block onto radio resource spanning on a larger BW, and/or schedule a transport block with a large size, eNB needs to know the UE capability. In LTE system, UE will report category/capability after receiving the configuration from eNB, i.e., a RRC message UECapabilityEnquiry. UE reports its category/capability in UEcapabilitylnformation element. However, for NB-IoT UP solution, the data package is transmitted in Msg5. Therefore, it is benefit to report UE category/capability in an early message. For simplification, in the following description, only UE capability is used, but the new UE capability could be called the new UE category, or the new UE feature to the person skilled in the art. And the “UE capability” is not limitation.

In addition, the current DCI format could not work for the new capability UE. For example, for UE with one HARQ process there is no field in DCI to indicate HARQ process number. However, to support more than one HARQ process, the field in DCI to indicate HARQ process number is needed such that the UE knows which HARQ process the scheduled grant belongs to. In another example, a UE with larger BW may need more bits for resource allocation, which results in a different DCI format. UE and eNB need a handshake to enable the new UE capability, such as supporting more than one HARQ process and/or to schedule a larger resource allocation on a wider bandwidth and/or schedule a grant with a large TBS. After the handshake, UE monitors for a new DCI format for its higher category or new feature.

In one embodiment, PRACH resources can be separated into two groups to report the new UE category/capability. For example, in NB-IoT system, each PRACH resource associated with a repetition level to extend the coverage. Within each PRACH resource, PRACH resources are partitioned into two groups for single/multi-tone Msg3 transmission. However, since the transport size (TBS) is limited, and there is no need to support multiple HARQ process, there is no need to report UE category by partitioning PRACH resource, which may increase collision probability. In addition, for the system with more than one PRACH coverage level, a power ramping is supported for the lowest repetition level, which can overcome the near-far problem for NPRACH for NB-IoT UE in normal coverage(NC). UE uses the max transmission power for other repetition levels for CE mode. The method of power ramping in case of more than one PRACH resource groups needs to be studied. In another embodiment, the UE reports the new category in MSG3. The new UE capability, which are more HARQ process and/or larger TBS and/or wide BW can be enable after MSG3. For example, for CP solution, the new feature/category can be used to improve the data rate. In another embodiment, UE could report the new category within the RRC message for UE category report.

Since some network may not be able to support UE with new capability, UE needs to know if the eNB can support the new capability so that UE can perform as a new capability UE, otherwise, UE performs as an old feature UE. In another novel aspect, the new UE capability is enabled by eNB, which is also called eNB enabler, or eNB based enabled. In one embodiment, one or more features can be enabled including to support more than one HARQ process and/or to schedule a larger resource allocation on a wider bandwidth and/or schedule a grant with a large TBS. In one embodiment, the eNB broadcasts the configuration of support of the new UE capability in SIB or dedicated RRC message or in MAC or in DCI, such as in MSG4. If the UE receives the configuration from eNB, the UE implements the new capability. The UE monitors a DL control channel in pre-defined rule to implement the new capability. The predefined rule includes monitoring a new DCI format in the UE-specific search space (USS) only, in both USS and common search space (CSS), or in CSS only. In the CSS only case, the CSS can be used for paging, or for RAR MSG3 retransmission, or MSG4. The predefined rule may also include monitoring the new DCI format right after obtaining the configuration for the eNB, or after the UE capability reporting, or in certain procedures, such as in the connected and/or IDLE mode, or during the RACH procedure.

In one embodiment, eNB broadcasts the configuration of support of the new category in SIB or dedicated RRC message or in MAC or in DCI. For example, in MSG4. If UE receives the configuration from eNB, UE implements the new capability. For example, UE monitors a DL control channel in pre-defined rule to implement the new capability. In one example, the pre-defined rule is one or combination of the following options:

1)Monitoring for a new DCI format: In option 1), there are three cases, comprising: A. In UE specific search space (USS) only; B. In both USS and common search space (CSS); C. In CSS only, in case C, the CSS could be the CSS used for paging, or CSS for RAR MSG3 retransmission and MSG4.

2)Monitoring for a new DCI format: In option 2), there are three occasions, comprising: A. Right after obtain the configuration from eNB; B. After UE capability reporting; C. In a certain procedure, e.g., in connected mode, and/or in Idle mode, during RACH procedure.

Further details and embodiments and methods are described in the detailed description below. The accompanying drawings, where like numerals indicate like components, illustrate embodiments of the invention.

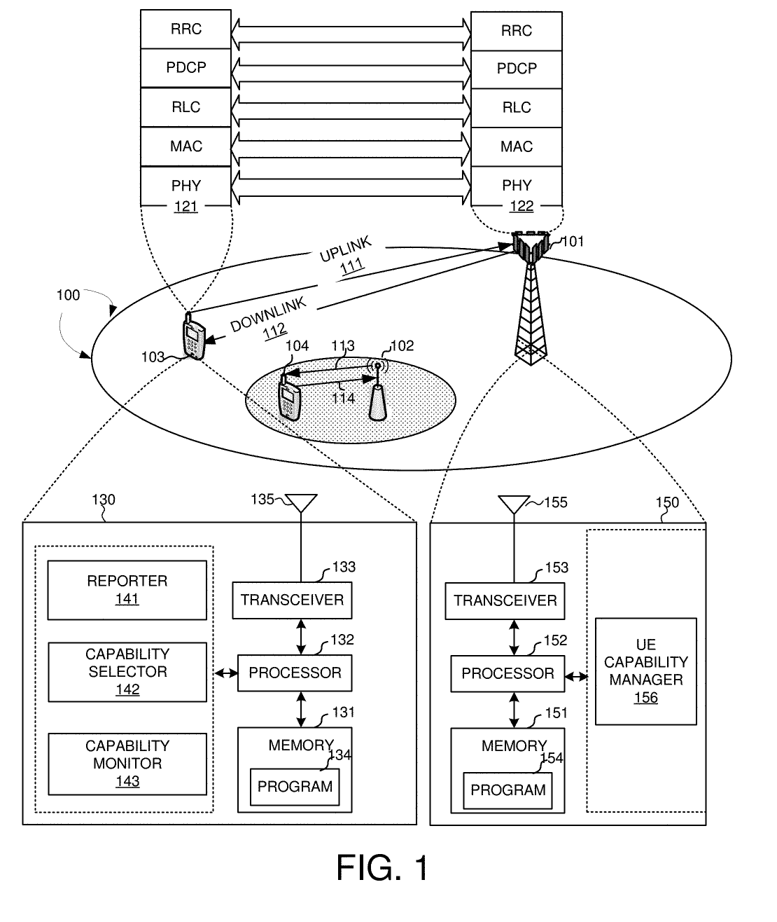

FIG. 1 illustrates an exemplary mobile communication network 100 with UEs supporting new UE capability in accordance with embodiments of the current invention. Wireless communication system 100 includes one or more fixed base infrastructure units forming a network distributed over a geographical region. The base unit may also be referred to as an access point, an access terminal, a base station, a Node-B, an eNode-B (eNB), or by other terminology used in the art. In FIG. 1, the one or more base stations 101 and 102 serve a number of remote units/user equipment (UEs) 103 and 104 within a serving area, for example, a cell, a sector, or an area within one transmitting and receiving point (TRP) within a cell. In some systems, one or more base stations are communicably coupled to a controller forming an access network that is communicably coupled to one or more core networks. The disclosure, however, is not intended to be limited to any particular wireless communication system.

Generally, the eNB 101 and 102 respectively transmit downlink communication signals 112, 113 to UE 103, and 104 in the time and/or frequency and/or code domain. UE 103 and 104 communicate with one or more eNB 101 and 102 via uplink communication signals 113, and 114 respectively. The one or more eNB 101 and 102 may comprise one or more transmitters and one or more receivers that serve the UEs 103 and 104. UE 103 and 104 may be fixed or mobile user terminals. The UE may also be referred to as subscriber units, mobile stations, users, terminals, subscriber stations, user terminals, or by other terminology used in the art. UE 103 and 104 may also comprise one or more transmitters and one or more receivers. UEs 103 and 104 may have half-duplex (HD) or full duplex (FD) transceivers. Half-duplex transceivers do not transmit and receive simultaneously whereas full-duplex terminals transmit and receive simultaneously. In one embodiment, one eNB 101 can serve different kind of UEs. UE 103 and 104 may belong to different categories, such as having different RF bandwidth or different subcarrier spacing. UE belonging to different categories may be designed for different use cases or scenarios. For example, some use case such as Machine Type Communication (MTC), or NB-IoT may require very low throughput, delay torrent, the traffic packet size may be very small (e.g., 1000 bit per message), extension coverage. Some other use case, e.g. intelligent transportation system, may be very strict with latency, e.g. orders of lms of end-to-end latency. Different UE capabilities/categories may be introduced for these diverse requirements. Different frame structures or system parameters may also be used in order to achieve some special requirement. For example, different UEs may have different RF bandwidths, subcarrier spacing, omitting some system functionalities (e.g., random access, CSI feedback), or use physical channels/signals for the same functionality (e.g., different reference signals).

FIG. 1 also shows an exemplary diagram of protocol stacks for control-plane for UE 103 and eNB 101. UE 103 has a protocol stack 121, which includes the physical (PHY) layer, the medium access control (MAC) layer, the radio link control (RLC) layer, the pack data convergence protocol (PDCP) layer, and the radio resource control (RRC) layer. Similarly, eNB 101 has a protocol stack 122. Protocol stack 122 connects with protocol stack 121. The eNB protocol stack 122 includes the PHY layer, the MAC layer, the RLC layer the PDCP layer and the RRC layer, each of which connects with their corresponding protocol stack of UE protocol stack 121.

FIG. 1 further illustrates simplified block diagrams 130 and 150 UE 103 and eNB 101, respectively. UE 103 has an antenna 135, which transmits and receives radio signals. A RF transceiver module 133, coupled with the antenna, receives RF signals from antenna 135, converts them to baseband signals and sends them to processor 132. RF transceiver 133 also converts received baseband signals from processor 132, converts them to RF signals, and sends out to antenna 135. Processor 132 processes the received baseband signals and invokes different functional modules to perform features in UE 103. Memory 131 stores program instructions and data 134 to control the operations of LC-UE 103.

UE 103 also includes multiple function modules that carry out different tasks in accordance with embodiments of the current invention. A reporter 141 reports a new UE capability to a base station in a wireless communication system. A capability selector 142 determines whether the base station supports the new UE capability. A capability monitor 143 monitors a new DCI format to implement the new UE capability in the UE-specific search space (USS) by the UE if the base station support the new UE capability, otherwise, monitoring for a default DCI format to implement the default UE capability by the UE.

Also shown in FIG. 1 is exemplary block diagram for eNB 101. eNB 101 has an antenna 155, which transmits and receives radio signals. A RF transceiver module 153, coupled with the antenna, receives RF signals from antenna 155, converts them to baseband signals, and sends them to processor 152. RF transceiver 153 also converts received baseband signals from processor 152, converts them to RF signals, and sends out to antenna 155. Processor 152 processes the received baseband signals and invokes different functional modules to perform features in eNB 101. Memory 151 stores program instructions and data 154 to control the operations of eNB 101. eNB 101 also includes function modules that carry out different tasks in accordance with embodiments of the current invention. A UE capability manager 156 performs functions to support the new UE capability management and communication with one or more UEs with the new UE capability enabled.

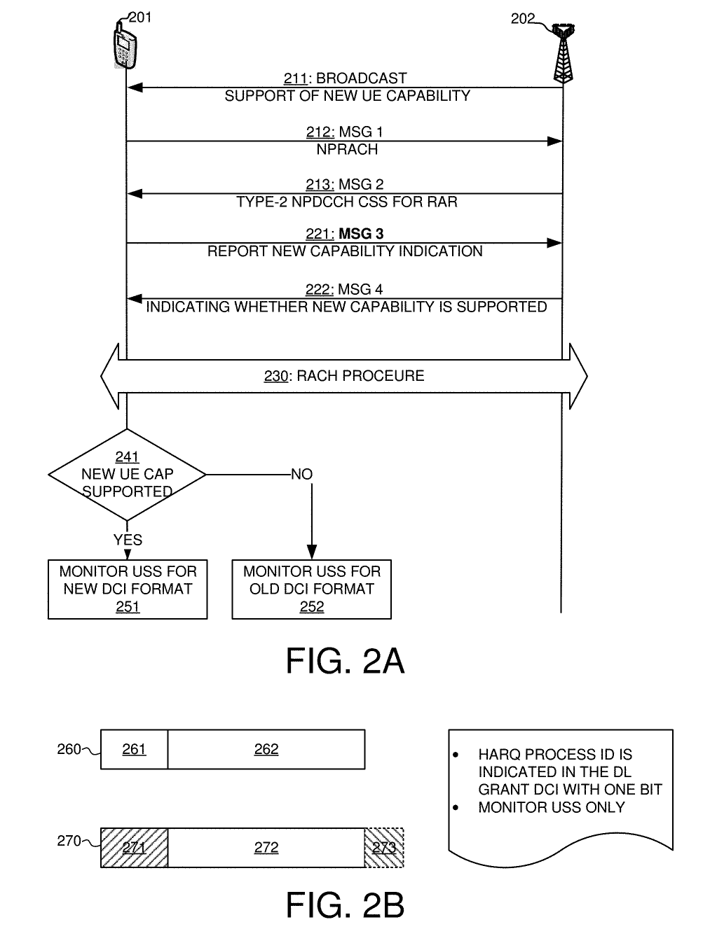

FIG. 2A illustrates an exemplary message procedure of the UE reporting the new capability and obtaining configuration of eNB support of the new capability in accordance with embodiments of the current invention. In one novel aspect, the UE performs as the new capability UE. In one embedment, the UE monitors the new DCI format in UE-specific search space (USS) if the obtains the new UE capability configuration in SIB. In another embodiment, the UE monitors for default DCI in common searching space (CSS) no matter UE implements as the new capability or legacy/default capability. The UE monitors the default DCI format in CSS, e.g., Type2-NPDCCH common search space for MSG3 re-transmission or MSG4. Alternatively, the UE monitors the default DCI format for paging, e.g., in Type 1-NPDCCH common search space. Some UEs in the IDLE mode or during random access channel (RACH) procedure do not require network/eNB to know the UE capability. For example, eNB treats all UEs as legacy UE before obtaining UE capability indication to avoid resource segmentation and improve system capacity.

When the UE performs with new capability, the UE monitors more DL control channel search space to improve data rate, shorten latency, and reduce UE power consumption. In one embodiment, the search space for DL control channel is between narrowband physical downlink control channel (NPDCCH) and the scheduled narrowband physical downlink shared channel (NPDSCH) or physical uplink shared channel (NPUSCH). In another embodiment, the search space for DL control channel is between NPDSCH and ACK/NACK. Further, since the UE is busy with NPDSCH decoding within the offset, the UE shall not be required to monitor NPDCCH between NPDSCH and its ACK/NACK. Furthermore, since there is limited benefit for the UE to support two HARQ processes during the RACH procedure, the UE only needs to monitor additional NPDCCH search space in the connected mode that is after the RACH procedure. The UE monitors the new DCI format in both USS and CSS. In one embodiment the UE performs as the new capability UE in order to support more HARQ processes and/or other new UE capability (e.g., large MAX TBS).

In order to minimize eNB effort on scheduling, the same timing offset for both UL and DL is better to be kept. That is the same timing offset between NPDCCH and NPDSCH, NPDCCH and NPUSCH format 1 and NPDSCH and its ACK/NACK. In addition, the timing offset is calculated per HARQ process. Alternatively, UE performs as new UE category/capability, e.g. enable two HARQ processes, different timing offset/scheduling delay may be used. More specifically, UE may map to different timing offset/scheduling delay table based on scheduling delay or HARQ/ACK resource field in DCI/RAR.

Since UE can expect two DCIs within one search space or an additional DCI between decoded DCI and its scheduled data channel, some “collision” may happen. However, eNB shall ensure there is no such error case and UE does not expect collision due to the two DCI. In addition, because of the two DCIs, NPDSCH and NPUSCH may be scheduled overlapped. The switching time from UL to DL needs to be reserved. Refer to eMTC, at least lms needs to be ensured by eNB. In another alternative, when collision happens, UE fully or partially drop one of the transport block or ACK/NACK. It can be based on a pre-defined rule or the UE implementation.

As shown in FIG. 2A, a UE 201 is connected with an eNB 202. At step 211, eNB 202 broadcasts the support of new UE capability in SIB (e.g., by a configuration), and the new UE capability, for example, more than one HARQ process, and/or wide BW, and/or large max TBS. UE obtains configuration in SIB, by determining if an information element (IE) present in SIB or not. In step 212, the UE transmits the PRACH/NPRACH in Msg1 to eNB 202. In step 213, UE monitors the type2-NPDCCH common search space for RAR. In one example, the DCI format in type2-NPDCCH CSS is common for legacy category and new category UE. In step 221, UE reports the new capability in MSG3. For example, using one reserved bit in MAC. In one example, UE only reports the new capability in MSG3 if UE obtains a configuration from eNB, for example, in SIB. In step 222, eNB transmits MSG4 to UE 201. In step 230, the UE performs the RACH procedure. In step 241, the UE determines if the new UE capability is supported after RACH procedure. In step 251, the UE monitors USS for the new DCI format, if the cell supports the new UE category. In step 252, UE monitors USS for legacy/default DCI format if the cell does not support the new UE category.

In one embodiment, if UE 201 and eNB 202 both support the new category, such as, more than one HARQ process, UE 201 could report this information in msg3 in step 221. In one embodiment, the reported information is element twoHARQProcessSupport (e.g., MAC control element or RRC element) included in MSG3. In another embodiment, the reported information is only in RRCConnectionRequest in the RRC Connection request message. In yet another embodiment, this information is also in RRC connection resume request message or in RRC Connection Re-establishment message. In step 213, UE 201 monitors the legacy DCI format in CSS for RAR. In step 221, UE 201 may monitor the legacy DCI format in CSS for MSG3 re-transmission. In step 252, UE monitors the legacy DCI format in CSS for MSG4. The UE monitors the old DCI format for paging, e.g., in Type 1-NPDCCH common search space.

FIG. 2B illustrates exemplary DCI formats in supporting of the new UE capability in accordance with embodiments of the current invention. A legacy DCI format 260 has a legacy transport block size (TBS) or modulation and coding scheme (MSC) table 261 and a DCI body 262. The resource assignment indicates the number of subframes or resource units for DL or UL resource block. Moreover, with the resource assignment and MSC, the UE can obtain a TBS based on a pre-defined TBS table. A new DCI formation 270 includes a new TBS or MSC table 271, a DCI body 272, and an optional new field for HARQ number 273. New TBS or MSC table 271 shows the field for new resource assignment and/or MSC. The UE implements as new capability by obtaining the TBS based on a new TBS table other than the legacy table, which UE uses when implementing as legacy capability. In another embodiment, the UE implements as new capability by obtaining the TBS based on a legacy TBS table with more entries. Similarly, UE may obtain the number of subframes or resource unit based on a new table (Table used for mapping resource assignment, i.e., I_{SF} to N_{SF} for NB-IoT NPDSCH and/or I_{RU} to N_{RU} for NB-IoT NPUSCH) for new DCI format. In one embodiment, the DCI field in new DCI format for resource assignment has the same size as in the legacy DCI format. In another example, the DCI field in new DCI format for resource assignment has the different size from the legacy DCI format. In the new DCI format, there is additional field 2030, which is the new field for HARQ process number. For example, this new field in additional payload or redefine existing field (e.g., repetition number, scheduling delay, TBS, MCS). In the new DCI format, there is additional field 273, which is the new field for HARQ process number. UE monitors a new DCI format as implementing the new capability. In one embodiment, the UE interprets the DCI field to with a new table as implementing the new capability and with a default table as implementing the default capability. Different TBS and/or MCS table are used for different max TBS or bandwidth.

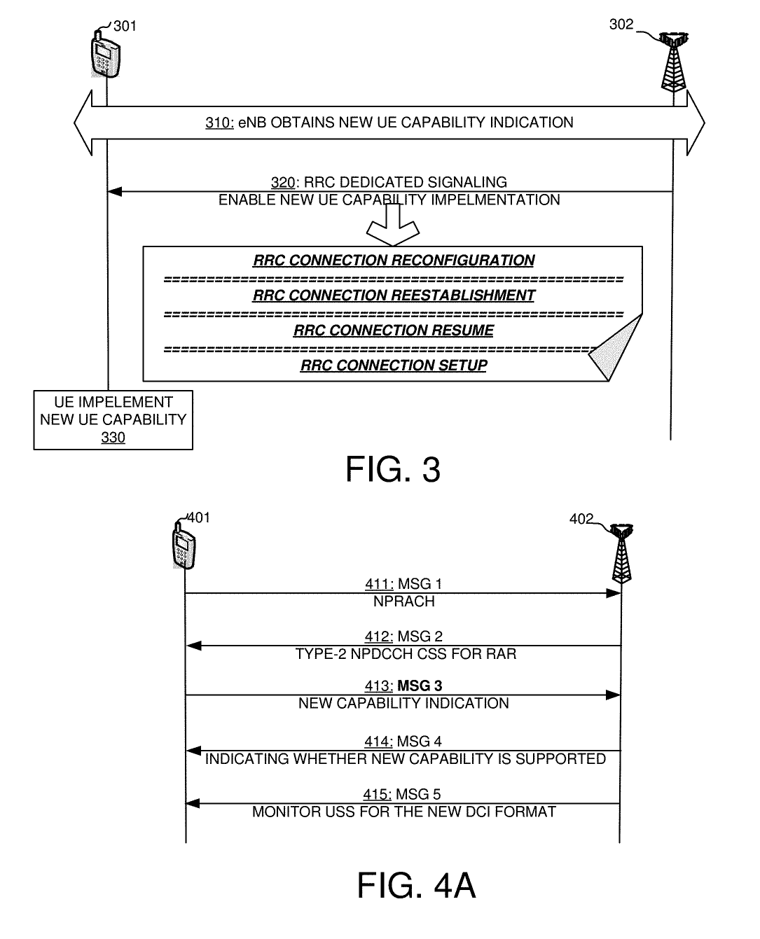

FIG. 3 illustrates an exemplary the message procedure of UE obtaining the support of the new UE capability from the eNB in accordance with embodiments of the current invention. A UE 301 is connected with an eNB 302. In step 310, eNB 302 obtains the new UE capability of UE 301. In one embodiment, eNB 302 obtains the new UE capability of UE 301 by decoding MSG3 from UE 301. In step 320, eNB 302 transmits the dedicated signaling to the UE 301 to enable new implementation of the UE with new capability. UE 301 obtains the configuration. In one embodiment, the information element (IE) in the dedicated signaling is a radio resource configuration in a RRC message. The RRC message is one or more of the following messages, RRC connection reconfiguration, RRC connection reestablishment, RRC connection Resume, or RRC connection setup. More specifically, UE obtains the indication in MSG4. In step 330, UE 301 implements the new capability. More specifically, the indication in an IE for dedicated physical configuration, e.g., NPDCCH-ConfigDedicated in physicalConfigDedicated or in radioResourceConfigDedicated. In one embodiment, the support of new UE capability indication is implied. UE 301 monitors NPDCCH for New DCI format, such as in USS, after obtaining an indicator for new DCI format in dedicated RRC signaling.

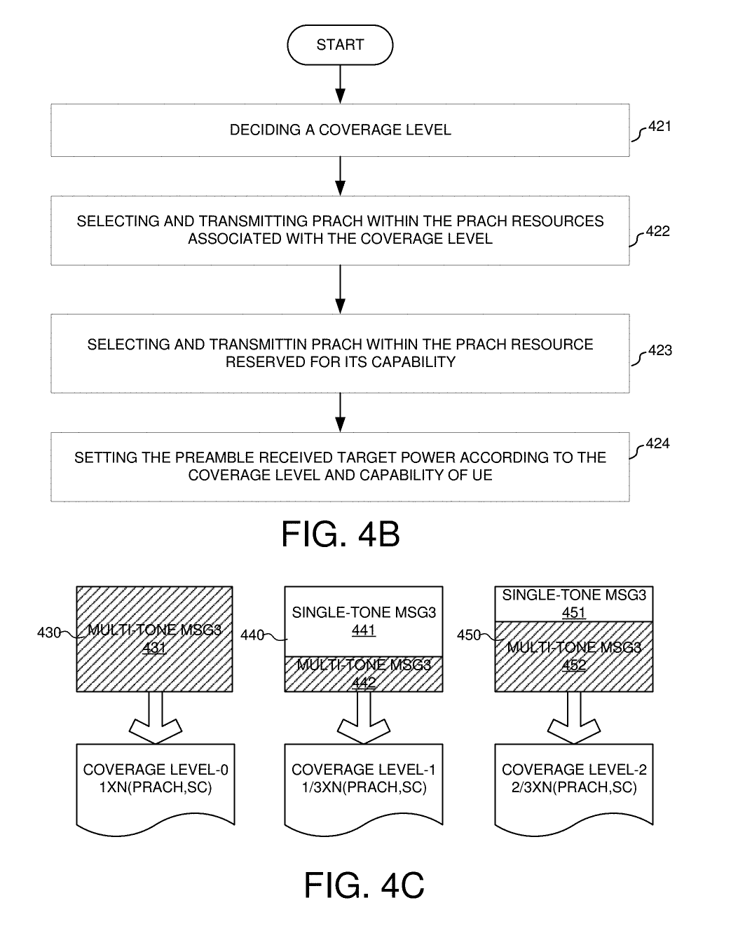

FIG. 4A illustrates an exemplary message procedure of UE reporting the new UE capability in accordance with embodiments of the current invention. A UE 401 is connected with an eNB 402. In step 411, UE 401 transmits the NPRACH in MSG1 to eNB 402. In step 412, UE monitors the type2-NPDCCH common search space for random access response (RAR). In step 413, the UE reports the new capability in MSG3 to eNB 402. In step 414, UE 401 obtains the indication from eNB 402 to use the new DCI format. This indication can be explicit or implicit. In one embodiment, the indication is in MSG4. Subsequently, in step 415, UE monitors USS for new DCI format for MSG5 and later receives the uni-cast channel from eNB 402.

In one embodiment, if UE 401 supports new UE capability or two HARQ processes, the information is indicated through twoHARQProcessSupport in RRCConnectionRequest message. In other embodiments, the information can be transmitted in RRC Connection resume request Message and/or RRC Connection Re-establishment message. The default DCI format is used in the CSS in steps 412 to 414. In step 415, UE 401 monitors for new DCI format in USS if obtain indication, otherwise, UE 401 monitor for old DCI format in USS.

FIG. 4B illustrates an exemplary flow chart of UE reporting NPRACH in accordance with embodiments of the current invention. In one embodiment, the UE transmits the NPRACH in a signaling message to the eNB based on its capability. In one embodiment, the signaling message is a single/multi-tone MSG3. In step 421, the UE decides a coverage level based on the reference signal received power (RSRP). In step 412, UE selects and transmits PRACH within the PRACH resource associated with the coverage level. The UE selects and transmits PRACH within the PRACH resource reserved for its capability, i.e., single/multi-tone MSG3 in step 413. In step 414, the UE sets the preamble received target power according to the coverage level and capability of UE to support of multi-tone Msg3 transmission. In one embodiment, the power setting for PRACH is based on the UE capability and the coverage level. For multi-tone Msg3 capable UE, the lowest coverage level of PRACH reserved resource for multi-tone Msg3, PREAMBLE RECEIVED TARGET POWER is set to PREAMBLE RECEIVED TARGET POWER−10*log 10(numRepetitionPerPreambleAttempt). For multi-tone Msg3 non-capable UE, the lowest coverage level of PRACH with reserved resource for single-tone Msg3, PREAMBLE RECEIVED TARGET POWER is set to PREAMBLE RECEIVED TARGET POWER−10*log 10(numRepetitionPerPreambleAttempt).

FIG. 4C illustrates exemplary diagrams of PRACH resource reserved for different capability in accordance with embodiments of the current invention. The lowest coverage level of PRACH is the lowest coverage level have PRACH resource reserved for the correspond capability. UE obtains PRACH configuration with three coverage levels, i.e., coverage level-0, level-1 and level-2. As shown in FIG. 4C, there are three resource sets, resource set 410, 440 and 450 for multi-tone MSG3, and single-tone MSG3 and multi-tone MSG3. In resource set 420, there are resource 441 for single-tone MSG3, and resource 442 for multi-tone MSG3, and in resource set 430, there are resource 451 for single-tone MSG3, and resource 452 used for multi-tone MSG3. All the PRACH resource in coverage level-0 are reserved for multi-tone MSG3 and part of PARCH resource in coverage level-1 and level-2 are reserved for multi-tone MSG3. The lowest coverage level for multi-tone MSG3 capable UE is coverage level-0 and the lowest coverage level for single-tone only MSG3 capable UE (i.e., non-multi-tone MSG3 capable UE) is coverage level-1. Multi-tone MSG3 capable UE performs power ramping (e.g., set PREAMBLE RECEIVED TARGET POWER based on a configuration from eNB as preambleInitialReceivedTargetPower). If selects PRACH resource in coverage level-0. And non-multi-tone MSG3 capable UE (single-tone MSG3 only capable UE) performs power ramping if selects PRACH resource in coverage level-1, where is actual available lowest coverage level is not the lowest coverage level in PRACH configuration.

Resource set 430 is for coverage level-0, what is {1 1}, and the number for PRACH resources is reserved for multi-tone MSG3 is the whole PRACH resource (i.e., 1×N_{SC}^{PRACH}). Resource set 440 is for coverage level-1. The number for PRACH resources 442 reserved for multi-tone MSG3 is ⅓ of the whole PRACH resource (i.e., ⅓×N_{SC}^{PRACH}) and the rest resource 441 is for single-tone MSG3. Resource set 450 is for coverage level-2. The number for PRACH resources 452 reserved for multi-tone MSG3 is ⅔ of the whole PRACH resource (i.e., ⅔×N_{SC}^{PRACH}) and the rest resource 451 is for single-tone MSG3.

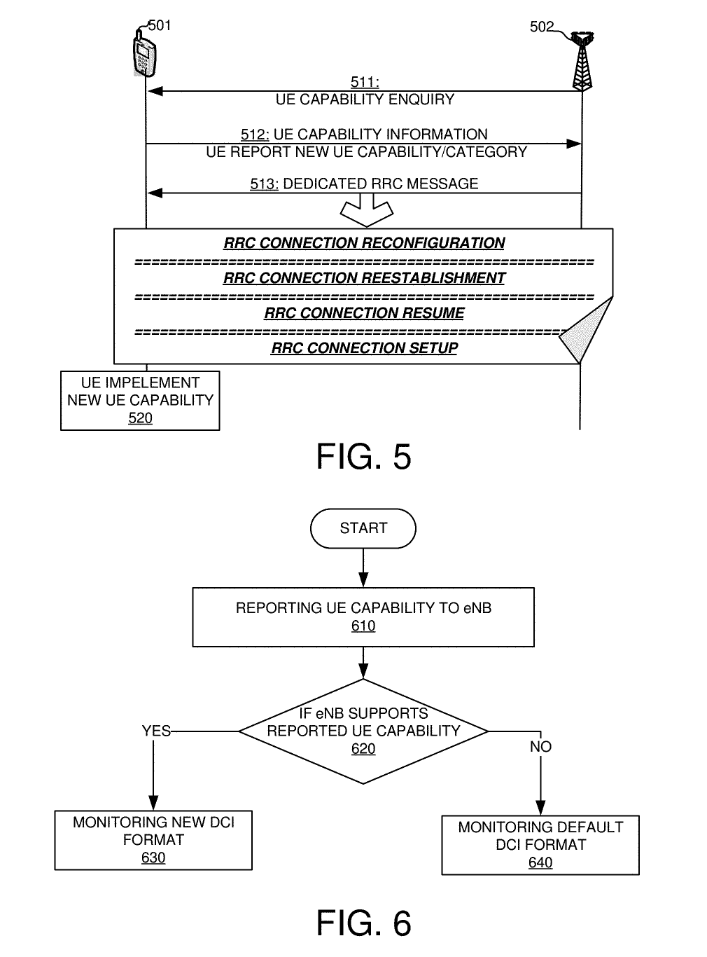

FIG. 5 illustrates an exemplary message procedure of the UE reporting the new UE capability/category and obtaining confirmation from the eNB in accordance with embodiments of the current invention. A UE 501 is connected with an eNB 502. In step 511, eNB 502 transmits the UE capability enquiry to UE 501 and UE 501 obtains RRC message for UE capability enquiry. In step 512, UE 501 reports the UE capability to eNB 502. In step 513, eNB 502 transmits the dedicated signaling to UE 501. The dedicated signaling, in one embodiment, is RRC connection reconfiguration in the RRC message. Upon receiving the new UE capability, eNB 502 configures UE 501 with corresponding configuration for the new UE capability/category. In one embodiment, a new IE can be inserted in a RRC message. For legacy eNB, it does not understand the new UE category/capability. There is no new RRC IE in the RRC message. In step 520, UE performs implementation as new capability. In one embodiment, UE 501 monitors the DL control channel search-space for the new DCI format after adopting the new configuration. The new UE capability/category is enough because the number of HARQ process goes well with no matter what the UE category is. UE 501 adopts new configuration if obtains the new IE in RRC message.

FIG. 6 illustrates an exemplary flow chart of UE reporting the new category in accordance with embodiments of the current invention. A UE is connected with an eNB. In step 610, UE reports a UE capability to eNB by a UE in the wireless system. In step 620, UE determines if the eNB supports the reported UE capability. If yes in step 620, UE goes to step 630, and performs as the new UE capability UE. In one embodiment, UE 601 monitors a new DCI format corresponding to the UE capability if eNB supports the reported UE capability. If step 620 determines no, UE goes to step 640 and performs as legacy/default UE capability UE. In one embodiment, UE implements the legacy/default UE capability, e.g., monitors for a default DCI format.

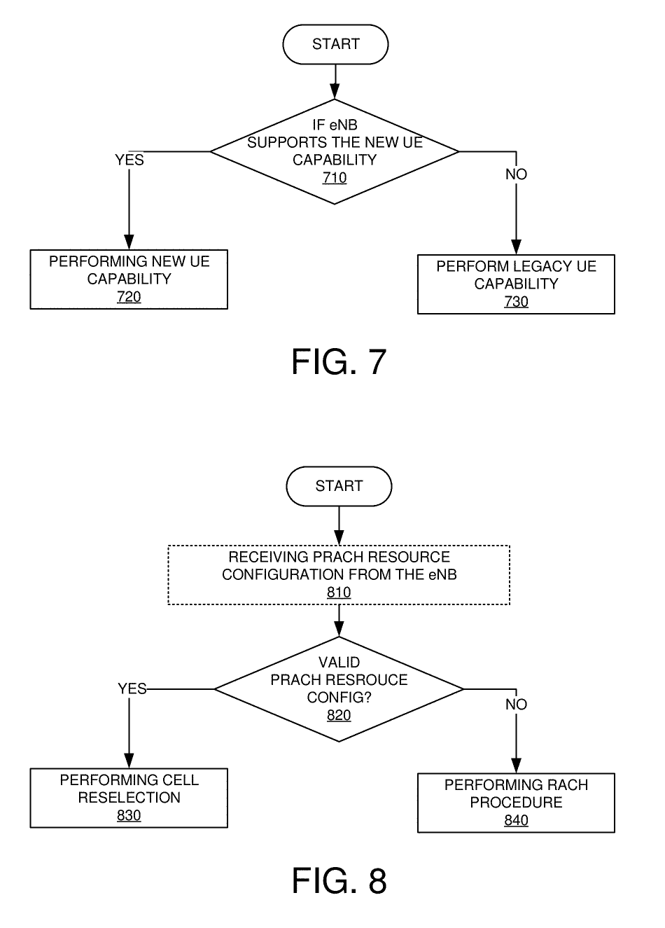

FIG. 7 illustrates an exemplary flow chart of UE reporting the new category after determining the support of the new UE capability from the eNB in accordance with embodiments of the current invention. In step 710, the UE determines if the eNB supports a new UE capability. If yes, the UE moves to step 720 and performs as new UE capability. In one embodiment, the UE reports a new UE capability to eNB. In one embodiment, the new UE capability is reported to the eNB in MSG3. If the UE determines no in step 710, the UE moves to step 730 and performs as legacy/default UE capability UE. The UE implements the legacy legacy/default UE capability and does not report a new UE capability to eNB.

FIG. 8 illustrates an exemplary flow chart UE with new UE capability for PRACH power ramping in accordance with embodiments of the current invention. In optional step 810, the UE receives PRACH resource configuration from the eNB. In step 820, the UE determines if the PRACH resource configuration is a valid configuration. If the UE determines no in step 820, the UE considers it implies an access barring of the UE capability and goes to step 830 to perform cell reselection. If the UE determines yes in step 820, the UE goes to step 840 to perform RACH procedure. In step 820, the UE supporting multi-tone MSG3 determines that the PRACH resource configuration is invalid, if more than one enhanced coverage levels for NPRACH are configured, and at least one of the NPRACH resource has reserved resource for multi-tone MSG3 except the resource of coverage level-0 has no reserved resource for multi-tone3. For example, PRACH resource in other coverage level is partition into two groups.

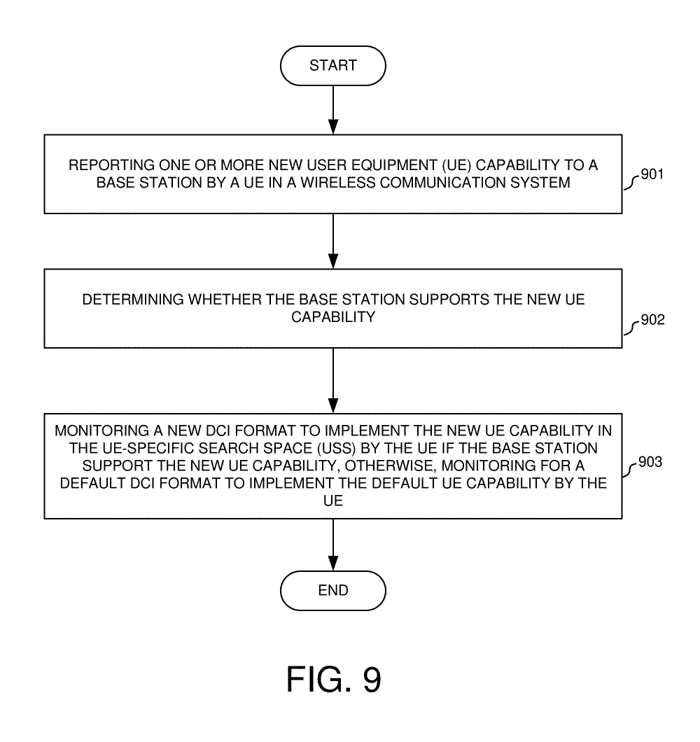

FIG. 9 illustrates an exemplary flow chart of UE implementing the new UE capability in accordance with embodiments of the current invention. In step 901, UE reports a new user equipment (UE) capability to a base station in a wireless communication system. In step 902, the UE determines whether the base station supports the new UE capability. In step 903, the UE monitors a new DCI format to implement the new UE capability in the UE-specific search space (USS) by the UE if the base station supports the new UE capability, otherwise, monitoring for a default DCI format to implement the default UE capability by the UE.

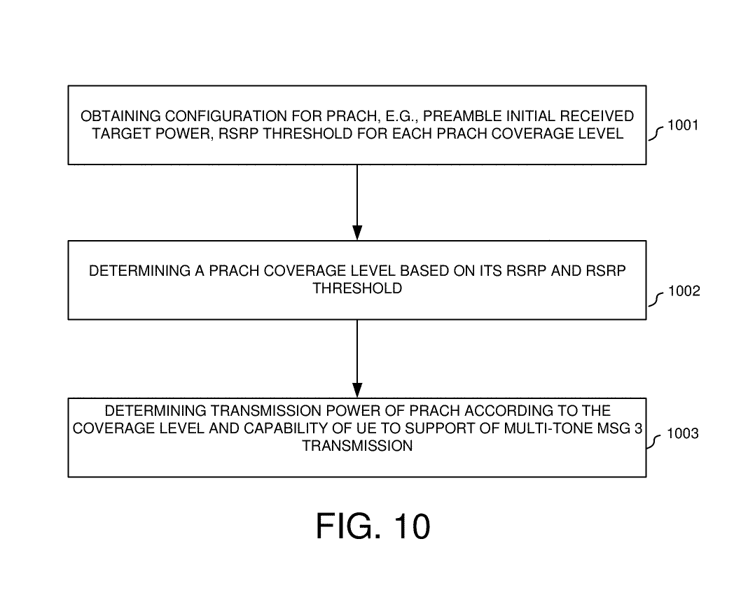

FIG. 10 illustrates an exemplary flow chart of for PRACH power ramping in accordance with embodiments of the current invention. In step 1001, UE obtains configuration for PRACH, e.g., preamble initial received target power, RSRP threshold for each PRACH coverage level. In step 1002, UE determines a PRACH coverage level based on its RSRP and RSRP threshold. Furthermore, UE determines a PRACH coverage level based on preamble transmission counter. In step 1003, UE determines transmission power (e.g., by setting preamble received target power) of PRACH according to the coverage level and capability of UE to support of multi-tone Msg3 transmission.

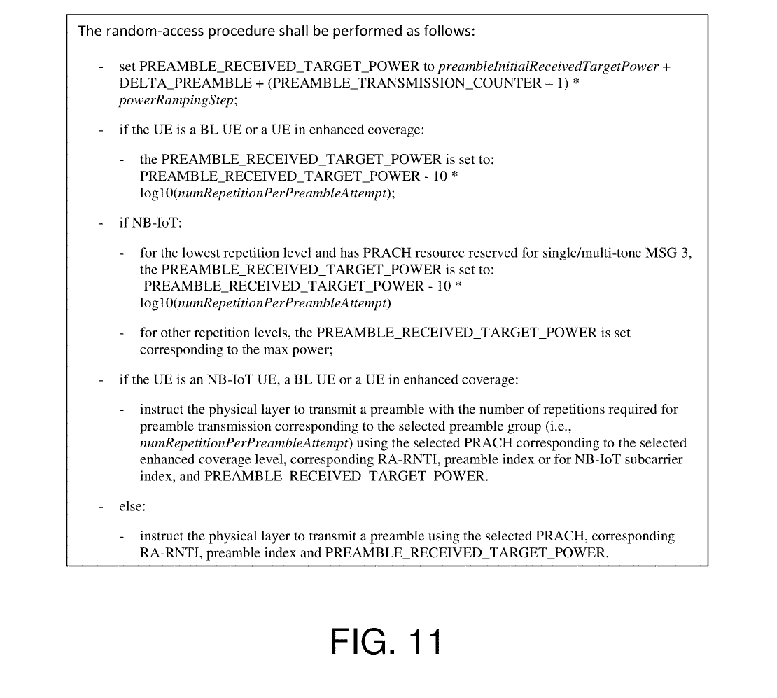

FIG. 11 illustrates a specific procedure for PRACH power ramping in accordance with embodiments of the current invention. For multi-tone Msg3 capable UE, for the lowest coverage level of NPRACH with reserved resource for multi-tone Msg3, setting PREAMBLE RECEIVED TARGET POWER to PREAMBLE RECEIVED TARGET POWER−10*log 10(numRepetitionPerPreambleAttempt)

For multi-tone Msg3 non-capable UE, for the lowest coverage level of NPRACH with reserved resource for single-tone Msg3, setting PREAMBLE RECEIVED TARGET POWER to PREAMBLE RECEIVED TARGET POWER−10*log 10(numRepetitionPerPreambleAttempt)

The random-access procedure shall be performed as follows: set PREAMBLE RECEIVED TARGET POWER to preambleInitialReceivedTargetPower+DELTA PREAMBLE+(PREAMBLE TRANSMISSION COUNTER−1)*powerRampingStep;

In the case of NB-IoT:

1) for the lowest coverage level with NPRACH resource for single/multi-tone Msg3, the PREAMBLE RECEIVED TARGET POWER is set to: PREAMBLE RECEIVED TARGET POWER−10*log 10(numRepetitionPerPreambleAttempt)

2) for other enhanced coverage levels, the PREAMBLE RECEIVED TARGET POWER is set corresponding to the max UE output power.

Further, UE sets set PREAMBLE RECEIVED TARGET POWER to preamblelnitialReceivedTargetPower+DELTA PREAMBLE+(PREAMBLE TRANSMISSION COUNTER−1)*powerRampingStep.

In the embodiments, the wireless communication system 100 utilizes an OFDMA or a multi-carrier-based architecture including Adaptive Modulation and Coding (AMC) on the downlink and next generation single-carrier (SC) based FDMA architecture for uplink transmissions. SC based FDMA architectures include Interleaved FDMA (IFDMA), Localized FDMA (LFDMA), and DFT-spread OFDM (DFT-SOFDM) with IFDMA or LFDMA. In OFDMA based systems, UE 103 and 110 are served by assigning downlink or uplink radio resources that typically comprises a set of sub-carriers over one or more OFDM symbols. Exemplary OFDMA-based protocols include the developing Long Term Evolution (LTE) of the 3GPP UMTS standard and the IEEE 802.16 standard. The architecture may also include the use of spreading techniques such as multi-carrier CDMA (MC-CDMA), multi-carrier direct sequence CDMA (MC-DS-CDMA), Orthogonal Frequency and Code Division Multiplexing (OFCDM) with one or two dimensional spreading. In other embodiments, the architecture may be based on simpler time and/or frequency division multiplexing/multiple access techniques, or a combination of these various techniques. In alternate embodiments, the wireless communication system 100 may utilize other cellular communication system protocols including, but not limited to, TDMA or direct sequence CDMA.

For example, in the 3GPP LTE system based on SC-FDMA uplink, the radio resource is partitioned into subframes, and each of the subframes comprises 2 slots and each slot has 7 SC-FDMA symbols in the case of normal Cyclic Prefix (CP). For each user, each SC-FDMA symbol further comprises a number of subcarriers depending on the uplink assignment. The basic unit of the radio resource grid is called Resource Element (RE) which spans an SC-FDMA subcarrier over one SC-FDMA symbol.

Each UE gets an assignment, i.e., a set of REs in a Physical Uplink Shared Channel (PUSCH), when an uplink packet is sent from a UE to an eNB. The UE gets the downlink and uplink assignment information and other control information from its Physical Downlink Control Channel (PDCCH) or Enhanced Physical Downlink Control Channel (EPDCCH) whose content is dedicated to that UE. The uplink assignment is indicated in downlink control information (DCI) in PDCCH/EPDCCH. Usually, the uplink assignment indicated the resource allocation within one certain subframe, for example k+4 subframe if DCI is received in subframe k for FDD and for TDD, the timing relationship is given in a table in TS 36.213. TTI bundling is used in uplink transmission in LTE system to improve uplink coverage. If TTI bundle is enabled, one uplink assignment indicates several subframes to transmit one transport block using different redundancy version (RV).

Uplink control information is transmitted in Physical Uplink Control Channel (PUCCH) or transmitted with or without a transport block in PUSCH. UCI includes HARQ, scheduling request (SR), channel status information (CSI). PUCCH is allocated the border PRBs in uplink system bandwidth. Frequency diversity gain for PUCCH is obtained by frequency hopping between two slots in one subframe. Code Division Mult lexing (CDM) is used for PUCCH multiplexing between different UEs on the same radio resource.

The embodiments of FIGS. 2-11 could be used in embodiment of FIG. 1, which is not limitation.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
reporting one or more new user equipment (UE) capability to a base station by a UE in a wireless communication system, wherein the one or more new UE capability comprises supporting of more than one HARQ processes;
determining whether the base station supports the new UE capability; and
monitoring a new DCI format to implement the new UE capability in the UE-specific search space (USS) by the UE if the base station supports the new UE capability,
otherwise, monitoring for a default DCI format to implement the default UE capability by the UE.

2. The method of claim 1, wherein the UE is a narrow band (NB) internet of things (IOT) device.

3. The method of claim 1, wherein the one or more UE capability further comprises at least one UE capabilities comprising a UE capability with larger buffer size, a UE capability supporting of wide bandwidth (BW), and a UE capability supporting of larger TBS.

4. The method of claim 1, wherein the reporting UE capability to the base station is in message 3 (MSG3).

5. The method of claim 1, wherein the UE obtains a configuration in system information (SI) to determine whether the base station supports the new UE capability.

6. The method of claim 1, wherein the UE obtains an indication in a dedicated RRC signaling to determine whether the base station supports the new UE capability.

7. The method of claim 6, wherein the indication is implied by a presence of a configuration of a DL control channel.

8. The method of claim 6, wherein the indication is explicitly indicated by an information element in a RRC message.

9. The method of claim 1, wherein the new DCI format for the new UE capability includes an indicator for a HARQ process number.

10. The method of claim 1, wherein implementing the new UE capability by mapping an new capability indicator in DCI to a information element (IE) and implementing the default UE capability by mapping an default capability indicator in DCI to a default IE.

11. A user equipment (UE) comprising:
a transceiver module that transmits and receives radio signals in a wireless network;
a reporter that reports one or more new UE capability to a base station, wherein the new UE capability comprises supporting of more than one HARQ processes;
a capability selector that determines whether the base station supports the new UE capability; and
a capability monitor that monitors a new DCI format to implement the new UE capability in the UE-specific search space (USS) by the UE if the base station support the new UE capability, otherwise, monitoring for a default DCI format to implement the default UE capability by the UE.

12. The UE of claim 11, wherein the UE is a narrow band (NB) internet of things (IOT) device.

13. The UE of claim 11, wherein the one or more UE capability comprises at least one UE capabilities comprising: a UE capability with larger buffer size, a UE capability of supporting of wide bandwidth, and a UE capability of supporting of larger TBS.

14. The UE of claim 11, wherein the reporting UE capability to the base station is in message 3 (MSG3).

15. The UE of claim 11, wherein the UE obtains a configuration in system information (SI) to determine whether the base station supports the new UE capability.

16. The UE of claim 11, wherein the UE obtains an indication in a dedicated RRC signaling to determine whether the base station supports the new UE capability.

17. The UE of claim 16, wherein the indication is implied by a presence of a configuration of a DL control channel.

18. The UE of claim 16, wherein the indication is explicitly indicated by an information element in a RRC message.

19. The UE of claim 11, wherein the new DCI format for the new UE capability includes an indicator for a HARQ process number.

20. The UE of claim 11, wherein implementing the new UE capability by mapping a new capability indicator in DCI to a new element and implementing the default UE capability by mapping an default capability indicator in DCI to a default element.
